(19) United States
(12) Patent Application Publication
(10) Pub. No.: US 2002/0179238 A1
(43) Pub. Date: Dec. 5, 2002

(54) Method and apparatus for edge joining of veneer strips

(76) Inventors: Hardy Vesterby Hansen, Olgol (DK); Per Vesterby Hansen, Ribe (DK)

Correspondence Address: Nixon Peabody, 8180 Greenboro Drive Suite 800, McLean, VA, 22102, US

(21) Appl. No.: 10/148,277

(22) PCT Filed: Nov. 29, 2000
(86) PCT No.: PCT/DK00/00654

(30) Foreign Application Priority Data
Nov. 29, 1999 PCT/DK99/00666
May 31, 2000 (DK) PA 2000 00856

(51) Int. Cl. B29C 65/00

(52) U.S. Cl. 156/304.3; 156/313; 156/304.6

(57) ABSTRACT

A method and an apparatus for edge joining of strip shaped plate or sheet elements of veneer (42, 48) by application of a hotmelt glue to at least one of the veneer edges to be joined and then forcing the elements (42, 48) together edge to edge before the glue solidifies, characterized in applying the glue in fully melted condition through heated nozzle means (40, 44) arranged so as to direct the applied glue as a jet or flow directly against a middle area of the relevant edge or edges is described. Preferably, the supporting area (2) for the opposite veneer strip (48) edge is located at a higher level (50) and preferably partly overhead the nozzle (40,44). By means of the described method and apparatus it is achieved that the total edge area of the veneer elements being heated, while gluing, is small, thereby not inducing any drying effect of importance on the veneer elements.

The present invention relates to a method and apparatus for edge joining of plate elements made of veneer. Such a joining is relevant because it has in practice been found desirable to produce plate elements with a surface which imitates a number of joined pieces of wood, ill particular for use in manufacturing of doors, cupboard doors and other furniture and building components, including floors. Thereby larger plate elements may be manufactured which have a pattern as if they consisted of parquet blocks, but which may be joined and supported in a much easier fashion than by the use of individual blocks.

It is thereby essential that the cut veneer may be brought stripwise to equipment which may perform an edge joining of the strips. Machines are known which may spread adhesive on the edge surfaces of the thin veneer strips and subsequently press them edge to edge against each other, but this technique has not been able to perform to reasonable quality standards, because it is almost impossible to avoid that adhesive breaks through on the top side of the joints which means that the finished elements must be subjected to a finishing operation.

Another technique which has become widespread uses a so-called adhesive filament, i.e. a thin carrier filament with a covering of a thermoplastic adhesive, said filament being made to move in a zig-zag fashion across the joint at the lower side of the element and being pressed against said lower side while the adhesive is heated to softening. In this way a sort of-sewing-together of the edge areas is performed, whereby both a reasonable joining and a complete elimination of adhesive from the surface are obtained.

This technique has been used with good results, but it is about to be overtaken by the ongoing development in which the thickness of the veneer has been minimised to such a degree that even the thin “adhesive sewing yarn” will display its thickness when the joined veneer plate element is placed on an underlying carrier plate. The filament will be noticed as local protrusions of the veneer surface at the joining zones. In view of the fact that it is the carrier filament itself which provides the strength in the joint, there is a limit to how thin this filament can be, and the result is hence that it has begun to manifest itself in an undesired manner.

Given this background, a novel method of joining has been sought for, in which even very thin veneer strips may be given a good edge joint without breakthrough of adhesive to the upper side of the joint zone and without joining means at its bottom side which would present a thickness.

From DE 1.026.066 it is known to use an adhesive filament which is controlled to be placed directly between the veneer strip edges which are brought together, whereby it is possible to adjust the adhesive dosage with such precision that the adhesive may remain in the joint and will not give any problems with break-through. There is, however, the problem that a heat-activated adhesive requires a heating, whereby it becomes sticky and may provoke a blockage in the filament transport. In the publication mentioned this is solved in chat the adhesive filament is supplied in a cold and non-sticky condition, and in that the activation of the adhesive occurs by means of heating of the whole joint zone. This technique is useless in practice, however, because while it does solve the adhesive problem, it creates a novel and fatal problem which is that the edge zones of the thin veneer strips are heated to extra dryness which will provoke bulges in the material and quickly make the process quite impossible to control.

According to the invention the principle of well-controlled adhesive supply to the edge joining zone is retained, but an external heating of the adhesive is provided for in such a maimer that no problems are created for the joining process or for the transport of the strips.

DE 3510147 discloses a technique, by which the veneer strips are conveyed between respective pairs of conveyor belts at either side of a sword, at the end of which there is arranged a vertical nozzle sending warm glue down against a carrier belt just underneath the still open joint between the strips. This belt closes the bottom of the joint, and its velocity is adjustable, whereby it is possible to lay out a sort of liquid thread with a controllable thickness just before the final closing of the joint. However, the nozzle mouth is located somewhat above the top side level of the strips, and with the narrow space conditions it is difficult to avoid deposition of glue at the top edge areas of both strips Of course, depositions could be avoided if the glue is applied so long ahead of the actual joining area that the veneer edges are still widely interspaced, but in that case the glue stripe between the application area and the joining area would exhibit a substantial length that would imply an undesirable cooling of the glue stripe before its entering the joining area; obviously for that purpose the referenced document discloses not only the use of hot glue, but additionally the use of hot air to be blown against the extruded glue, which is still undesired in connection with the invention.

According to one aspect of the present invention there is provided a method for edge joining of strip shaped plate or sheet elements of veneer in accordance with claim 1. It is hereby essential that the adhesive, which is supplied in an already fully heated and softened condition and in a measured amount to avoid excess adhesive in the joint, does not be subjected to heating after the provision of the adhesive which would also affect the joining edge areas of the veneer strips themselves. The supplied warm adhesive will obviously in itself cause a certain heating of these areas, but when this heating is concentrated to act upon the adhesive itself before its application, the general heating of the edge areas will be very limited, due to the fact that the adhesive is supplied in a very limited amount. The total heating of the edge areas will hence not cause any drying effect on the wood of importance, so that the manufacture may be performed without problems stemming from such a partial drying and with a very precise application of the glue at the veneer edge surface.

When applying the glue, whether holtmelt or cold glue, to a veneer edge directly from a nozzle laterally against the edge surface the veneer strips should be separated sufficiently to make space for the nozzle. Conventionally this implies a rather long distance between the point of application and the area of pressing the veneer edges against each other. It is an important aspect of an embodiment of the invention that this distance can be reduced considerably in arranging for the veneer strips to be fed to the nozzle area at two different levels, one above and in over the top of the nozzle, whereby the horizontal spacing can be quite small, just sufficient to enable the edges to be brought to the same level without the glue being wiped off. The veneer is readily flexible out of and into its own plane, so in this manner the lateral pushing together of the edges will be highly facailitated.

In the following the invention is described in more detail with reference to the drawing, in which

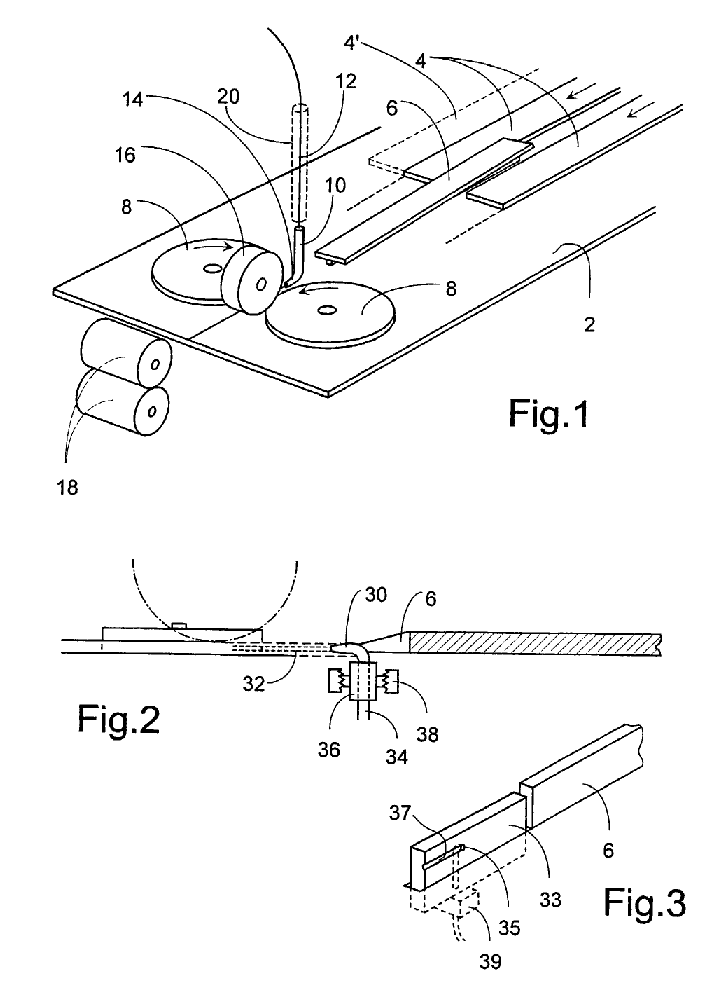

FIG. 1 is a schematic perspective view of a joining apparatus for veneer strips,

FIG. 2 is a side view of such an apparatus modified according to the invention,

FIG. 3 is a perspective view of a detail of another modification

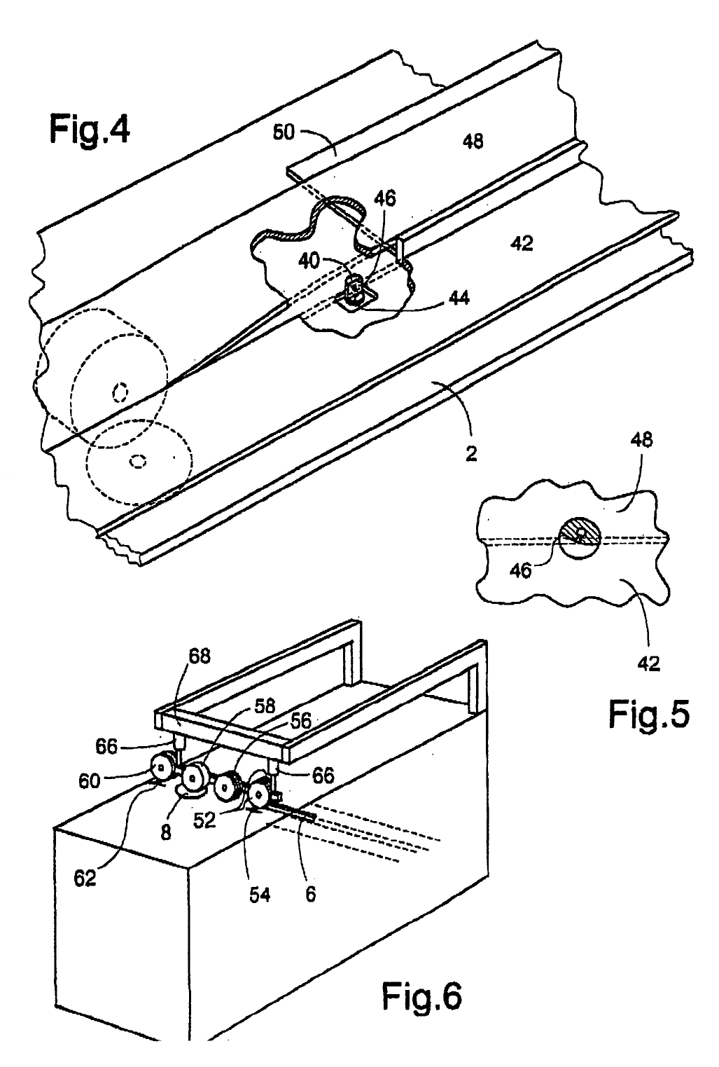

FIG. 4 is a perspective view of a preferred embodiment of the invention,

FIG. 5 is a cross sectional view of a nozzle unit therein, and

FIG. 6 is a perspective view of a complete apparatus according to the invention.

In FIG. 1 is shown the table top 2 of a machine on which have been placed two veneer strips 4, to be transported in the direction of the arrow. One or both of the strips may already be edge joined with further strips 4′. The strips have been placed from either side below a lengthwise disposed Trail 6, the top flange of which is slanting in the forward direction. Further ahead the strips 4 pass a pair of oppositely rotating, horizontal discs a which perform a slight compression on the strips 4, by means of friction, assisted by overhead pressure rollers (not shown). Immediately before this stage the strips pass a centrally placed guide the 10 for carrying an adhesive filament 12 to the butt seam area between the two strips 4, as the adhesive filament is discharged through a forwards-pointed discharge tip 14 of the guide tube 10. Hereafter the joined strips pass a pressure roller 16 and a pair of pull rollers 18.

This apparatus belongs to the prior art, but apart from the system for supplying the adhesive filament 12 the apparatus is fully usable in connection with the invention.

In FIG. 2 is shown an embodiment of the invention, in which the adhesive is brought to the joint as a narrow jet 32 of a heated, liquid adhesive ejected from a nozzle 30, which jet hits precisely on at least one edge surface of the veneer strips immediately before they are brought against each other. The supply tube 34 to the nozzle 30 is brought through a heating unit 36, preferably electrical, which is located so close to the nozzle 30 that upon start after a period of rest it will heat the nozzle itself to melt solidified adhesive therein. The unit 36 may be combined with height adjustment means, such as a surrounding adjustment screw 38, by means of which the height of the nozzle may be finely adjusted to ensure that the jet 32 of adhesive hits precisely in its target zone.

It will be understood that the adhesive must be supplied to the heating unit 36 at sufficient pressure and in a preheated condition, but it is considered that this constitutes technical details, which do not require further discussion here. The result is that it is possible to establish a directed jet which is so precise that will imitate the use of a hot adhesive filament.

It is shown in FIG. 3 that immediately after the end of the T-rail 6 there may be placed a height-adjustable block 33 which has a narrow bore 35 from which a narrow passage 37 leads in the side of the block The bore 35 is connected to a vertical channel which is connected to a magnet valve 39 to control adhesive supply from a hose with adhesive. In the front end of the block 33 there is fitted a heating element (not shown) for local heating of the supply zone for the adhesive so that it may be fully liquid during the application to the veneer edge. The bore 35 may be quite narrow, e.g. 0.2-0.4 mm, whereby the adhesive may be applied with high precision on the thin edge surface of the-veneer. It is preferable to use a pressure roller or a spring-loaded finger for the veneer edge at the place of application so that it will be correct even if the veneer should curve somewhat.

FIG. 4 shows a preferred embodiment, in which the nozzle, here designated 40, is made as a small round unit having a wall facet 46 with a thin, laterally oriented nozzle hole 44. The unit 40 is preferably height adjustably supported for fine adjustment according to the thickness of the veneer to be joined, and it may even be angularly adjustable in order to be turnable or turned-into a position in which the axis of the nozzle hole 44 is directed slightly obliquely in the forward direction of travel of the veneer, such that the delivery of glue from the nozzle hole is not directly blocked by the related veneer edge.

As an important feature the opposite veneer strip, designated 48 is supported by a carrier plate 50 in a level above the table 2 and above the top of the nozzle unit 40, such that the edge of this strip, seen horizontally, may be located in over the top of the nozzle unit as also indicated in FIG. 4. This implies that immediately prior to the application of the glue the edges of the strips can be so closely juxtaposed that they can very soon hereafter be totally joined by a combined guiding down of the strip 48 and a lateral bringing together of the strips 42 and 48 at the table 2. This conditions that the joining can be effected so rapidly after the application of the glue that the glue will still have a temperature and a consistency that will ensure its efficiency in the edge joining operation.

It is shown in FIG. 5 that the wall facet 46 may be arched or broken to ensure that the veneer edge will not prevent discharge or glue from the nozzle hole 44.

In this connection it is important to emphasize that the glue supply should be adjusted in such a manner that it will correspond to the flow of glue as desired and enabled to be carried away be the travelling veneer edge. The glue is not “sprayed” against the veneer edge as in FIG. 2, as it is merely supplied in bulk, without any excessive pressure, to the space between the nozzle hole 44 and the relevant veneer edge so as to satisfy the conditions with respect to the desired degree of glue coverage of the veneer edge. This again will be a question of the character and viscosity of the glue, but experts in the relevant field will be able to determine these process parameters in more detail. The product RAKOLL M 2000 seems recommendable.

As suggested especially in FIG. 3 it will be possible to effect a smaller or larger current filling up of the groove 37 with glue to be conveyed by way of its deposition on the relevant veneer edge, all according to the desired amount of glue to be deposited on the veneer edge. The same, of course, will apply to the more restricted space outside the nozzle hole 44 in FIG. 4, no matter how the relevant controlled spacing is established. The glue consumption can be rather low, e.g. in the range of 10-50 mg per meter, typically about 25 mg/m.

A machine according to the invention is schematically illustrated in FIG. 6 in its entirety. The veneer strips enter the machine table 2 at either side of the sword i, passing under opposed pressure rollers 52 that may cooperate with the top of driven rollers 54 underneath the table 2. According to FIG. 4 there is slightly elevated support 50 at one side of the sword. A double roller 56 is placed over the delivery end of the sword 6 and right over the nozzle 40, and a broad roller 58 is placed so as to cooperate with the friction discs 8 of the table 2 (FIG. 1). A broad delivery roller 60 cooperates with a lower driving roller 62.

The rollers are arranged so as to be forceable down against the table 2, preferably in an individual manner, but here shown as a collective mounting on a beam 64 held by pressure cylinders 66 on a chassis element 68 extending over the table 2 from the right hand side thereof, thus leaving space on the table for the joining of further veneer strips to already built-up plate elements,

More pressure rollers can be provided between the rollers 58 and 60.

1. A method for edge joining of strip shaped plate or sheet elements of veneer (42, 4B) by application of a hotmelt glue to at least one of the veneer edges to be joined and then forcing the elements together edge to edge before the glue solidifies, characterized in applying preheated glue. (32) in a fully melted condition from an external supply through a further heated nozzle means (40) comprising 10 adjusting means for final adjustment of the glue temperature at the moment of application, said nozzle means (40) being arranged so that it directs the applied glue as a jet (32) or flow directly against a middle area of the relevant veneer edge or edges.

2. A method according to claim 1, whereby the veneer strips (42, 48) are caused to be joined in being moved forwardly side by side, at first with some lateral, narrowing spacing between their adjacent edges while passing the glue application station (40), and thereafter in being pressed together edge to edge, characterized in that the opposed strips (42, 48) are guided or supported in such a manner that by their passage of the glue application station (40) they are interspaced relatively narrowly in the lateral direction, while also being interspaced vertically to such an extent that at least one of the edges can pass a nozzle element (40) that may even broader than the lateral spacing between the edges, Thereafter the strips (42, 48) are guided into a common level and pushed together for joining the edges thereof.

3. A method according to claim 1, whereby the glue (32) is applied to a veneer strip edge through a heated nozzle (40) directly contacting the veneer edge, and whereby the glue (32) is supplied at such a rate, by which it is carried away from the nozzle (40) in order to be deposited with a desired layer thickness on the veneer edge, typically amounting to some 25 mg per meter of the edge.

4. Ant apparatus for carrying out the method according to claim 1, with pressing means (8) for continuous pressing of veneer strips (42, 48) conveyed in parallel and adhesive supply means (40) for the supply of adhesive to at least one of the two strip edges which are to be joined, the apparatus being adapted to function with adhesive of the type which is activated by cooling from a heated condition, characterized in that, said adhesive supply means is embodied as an external supply of pre-heated adhesive connected to a further heated nozzle means (40) which is arranged adjacent to a support area for the edge of a veneer strip and comprises glue temperature adjusting means so as to deliver a jet (32) or flow of hot adhesive directly against a middle area of the edge surface of the veneer strip.

5. An apparatus according to claim 4, in which the nozzle (40) is located immediately next to the conveying path of the veneer edge.

6. An apparatus according to claim 4, in which the supporting area (50) for the opposite veneer strip edge is located at a higher level and preferably partly overhead the nozzle (40).
